(19) United States
(12) Patent Application Publication
(10) Pub. No.: US 2024/0264363 A1
(43) Pub. Date: Aug. 8, 2024

(54) Ultra-Wideband Low Latency Multicore to Multicore Free-Space Optical Communications Using Parabolic Mirrors

(71) Applicant: Panduit Corp., Tinley Park, IL (US)

(72) Inventors: Yu Huang, Orland Park, IL (US); Richard J. Pimpinella, Prairieville, LA (US); Jose M. Castro, Naperville, IL (US); Bulent Kose, Burr Ridge, IL (US)

(73) Assignee: Panduit Corp., Tinley Park, IL (US)

(21) Appl. No.: 18/106,136

(22) Filed: Feb. 6, 2023

(51) Int. Cl. G02B 6/02; G02B 6/35; G02B 6/36; G02B 27/30

(52) U.S. Cl. CPC G02B 6/02304; G02B 6/3512; G02B 6/366; G02B 27/30

(57) ABSTRACT

A low latency free-space optical data communication channel has at least two opposing parabolic mirrors for transmitting an optical communication signal in the form of a parallel beam across a free-space channel. The input and output of the collimators are multicore optical fibers. Multiple cores of the multicore optical fibers are positioned at the focal points of the at least two opposing parabolic mirrors and the at least two opposing parabolic mirrors image the optical communications signal in each core of the multiple cores of the multicore fibers into corresponding cores of opposing multicore fibers forming at least one optical communication channel.

### FIELD OF INVENTION

The present invention generally relates to high-speed optical fiber communication channels and, more specifically, to low-latency optical channels. The disclosed apparatus and method enable optical communication signals to propagate through free space, thereby traveling at the speed of light in the air, minimizing propagation time. In addition, the disclosed apparatus and method provide low-latency optical signal paths for a multiplicity of discrete channels, equalizing the propagation delay between adjacent channels.

### BACKGROUND

Free-space optical communications (in various forms) have been used for thousands of years. For example, the ancient Greeks used a coded alphabetic system of signals to communicate, utilizing torches. In 1880, Alexander Graham Bell demonstrated voice communications over free-space optics between two buildings some 213 meters apart. Free-space optical communications are widely used in commercial, military, and space applications.

In high-speed trading in financial markets, traders demand minimum transaction delay and guaranteed equivalent optical signal delay compared to other traders. These high-speed transactions propagate over standard single-mode and multimode optical fibers. To ensure equal trading delays, optical fiber cable assemblies are custom manufactured. The fiber lengths within the cable are precisely measured using optical time domain reflectometers (OTDRs) to ensure the optical channel delays are equivalent.

The speed of an optical signal is determined by the refractive index of the medium in which it propagates, where the refractive index is the optical dielectric constant of the medium. The refractive index, n, is defined by,

n=c/v [1]

where c is the speed of light in a vacuum (299,792,458 m/s), and v is the speed of the optical signal in the medium. Generally, the refractive index of glass used in optical fibers is about 1.467. Hence, the speed of light in optical fiber is 204,357,504 m/s, or 68% of the maximum speed of light in a vacuum. Given a typical channel length of 75 m, the time of flight in a vacuum is 250 ns. For light propagating through glass optical fiber, the time of flight for a 75 m channel is 367 ns, introducing a delay of 117 ns, or 0.117 μs. For high-speed trading, this is not acceptable.

To reduce the propagation delay of the optical channel, fiber manufacturers are developing hollow core fibers (HCF), where the core is a channel of air surrounded by an array of hollow tubes forming reflective micro-structures cladding to confine the optical beam, FIG. 1.

The authors of this disclosure measured the refractive index and hence the optical signal delay in a commercially available HCF. The refractive index was n_{hcf}=1.000476, yielding a 0.0476% delay compared to vacuum. This means the speed of light in HCF is almost as fast as in a vacuum, and HCF should fit the need for high-speed trading. However, these fiber types are complicated to manufacture in high volume and are extremely expensive, i.e., hundreds to thousands of dollars per meter. Furthermore, HCF also exhibits high attenuation (insertion loss) due to the coupling of the light's electromagnetic fields with the surrounding fiber core structure. In addition, due to the highly controlled spacing between fiber core elements, these fiber types are very fragile and susceptible to degradation in performance due to bending. Consequently, HCF must have a robust cable design and a large bend radius not to deform or damage the core structure. Hence, there is a need for a low-cost solution where the optical signal propagates near the speed of light in a vacuum so that channels of said communication signals undergo minimum delay, and traders can be guaranteed equivalent optical channel paths.

In U.S. patent application Ser. No. 17/955,676, which is herein incorporated by reference in its entirety, we disclose the apparatus and method for free-space optical communication channels to be used in high-speed, low-latency applications where the channels do not have to utilize expensive hollow core fibers. FIG. 2 illustrates the optical components and method for such free-space optical communication channels, where fiber 100 is a multicore optical fiber.

Multicore optical fiber 100 is shown with a typical protective acrylic coating 110. However, the fiber contains multiple single-mode cores within the standard 125 micron outer diameter, referred to as a multicore fiber. In this case, the fiber end face 102 reveals seven discrete cores, a central core 103, surrounded by 6 cores 104 in a hexagonal configuration. Therefore, we can utilize core 103 for optical alignment functions for this fiber core configuration. In contrast, the remaining cores can be used to support three duplex or six Bi-directional (BiDi) optical communication channels, which connect to the fanout pigtails 120 of the multicore fiber.

In the optical channel shown in FIG. 2, a transmitted optical communications signal emitted from the output end face of optical fiber 100 diverges at an angle θ defined by the fiber's numerical aperture (NA). To transmit the optical signal over a given distance, the light beam must be collimated to minimize the signal divergence and, therefore, the channel insertion loss, providing a signal amplitude high enough for the receiver to detect an error-free signal. This is achieved by placing an optical fiber 100 at the focal point 101 of lens 112. The multiple optical communication signals emanating from the seven discrete cores of fiber 100, positioned at the focal point of lens 112, produced a collimated beam 160. As a result, the optical beam impinges on receiving lens 132, and the transmitting cores are imaged onto the corresponding cores in fiber 130, resulting in three duplex or six BiDi free-space optical communication channels.

As the transmissive collimating lens system using multicore optical fibers provides an efficient and relatively low-cost solution to low latency communication, the transmissive lenses have aberrations, such as chromatic aberration, which cannot focus all colors or wavelength to the same point (FIG. 3) hence limit the spectrum of the optical signal. Therefore, it would be beneficial to eliminate all these aberrations in the free-space optical communication channels.

### SUMMARY

A low latency free-space optical data communication channel has at least two opposing parabolic mirrors for transmitting an optical communication signal in the form of a parallel beam across a free-space channel. The input and output of the collimators are multicore optical fibers. Multiple cores of the multicore optical fibers are positioned at the focal points of the at least two opposing parabolic mirrors and the at least two opposing parabolic mirrors image the optical communications signal in each core of the multiple cores of the multicore fibers into corresponding cores of opposing multicore fibers forming at least one optical communication channel.

### BRIEF DESCRIPTION OF THE FIGURES

FIG. 1 shows the cross sections of various hollow-core fibers.

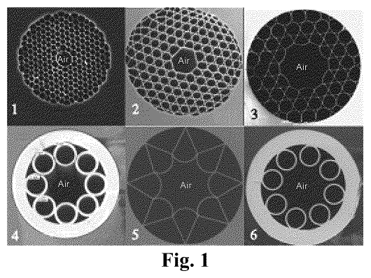

FIG. 2 shows an optical channel using collimated lenses.

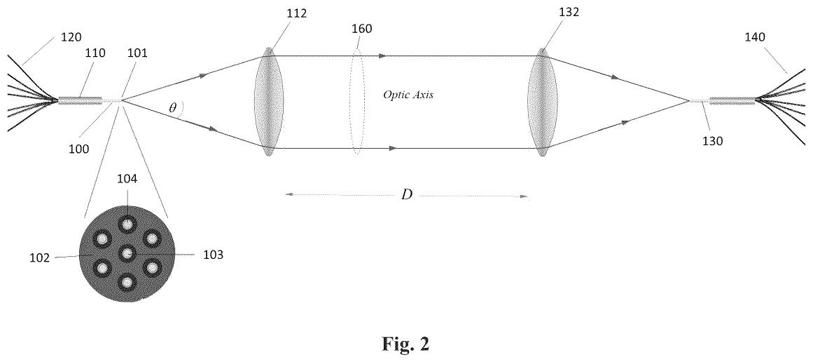

FIG. 3 shows how chromatic aberration can be an issue with collimating lenses.

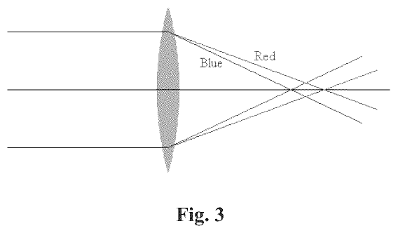

FIG. 4 shows an off-axis parabolic mirror.

FIG. 5 shows an optical channel using a pair of off-axis parabolic mirrors in place of the collimating lenses of FIG. 2.

FIG. 6. shows the need for rotational alignment.

FIG. 7 is an isometric view of a raceway that can be used with the present invention.

FIG. 8 show typical optical positioners, which can be used to perform the necessary alignment of the disclosed optical system.

FIG. 9 shows an assembly of a multicore-fiber, linear positioners, a rotation stage, a parabolic mirror, and a channel raceway to be used with the present invention.

### DESCRIPTION OF THE INVENTION

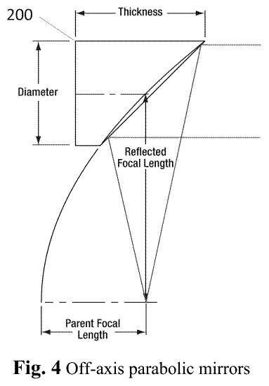

Off-axis parabolic (OAP) mirrors 200 are mirrors whose reflective surfaces are segments of a parent paraboloid, as shown in FIG. 4. They focus a collimated beam to a spot or collimate a divergent source. The reflective design eliminates chromatic aberration and other types of aberrations introduced by transmissive optics and makes these well-suited for use with wide-band free-space optical communication.

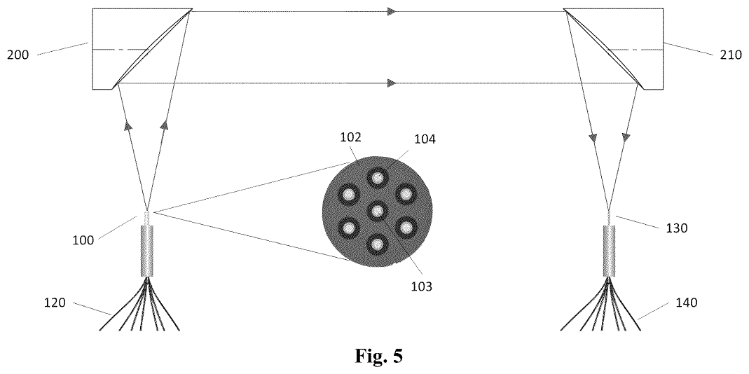

FIG. 5 illustrates the optical components and method for such wide-band free-space optical communication channels using parabolic mirrors. A transmitted optical communications signal emitted from the output end face of optical fiber 100 diverges at an angle and is collimated by the parabolic mirror 200. The optical beam impinges on receiving parabolic mirror 210, and the transmitting cores are imaged onto the corresponding cores in fiber 130, resulting in three duplex or six BiDi free-space optical communication channels.

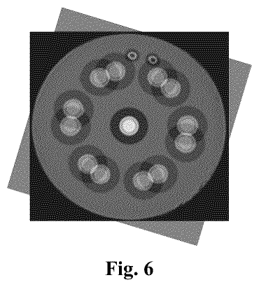

As illustrated in FIG. 6, it is insufficient only to align the central core. A rotational alignment is required to align the surrounding cores. This can be achieved by utilizing one more pair of mating cores to monitor and adjust the angular positioner to align the radially offset cores. One exemplary method to adjust the angular rotation is to add two 90:10 1×2 fiber splitters to two of the fanned-out cores to monitor the power for alignment. This way, all seven channels can still be used for data center communication.

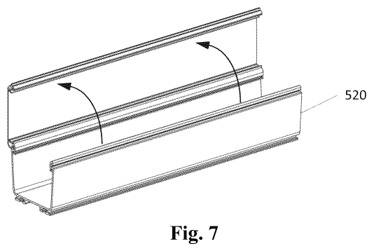

To protect and enclose the low latency free-space optical channel for communication applications according to the present invention, the collimated light path is enclosed within a channel raceway 520 as those commonly used to carry fiber optic cables (FIG. 7). The use of commercial data center raceways provides all the necessary hardware, installation practices, and industry certifications for safe use. In the preferred implementation, raceway 520 is a polymer material enclosed with a lid. Clearly, any enclosed or partially enclosed pathways can be used to protect the optical beam from unwanted obstructions.

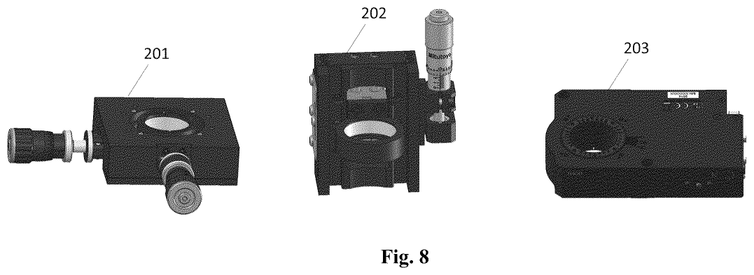

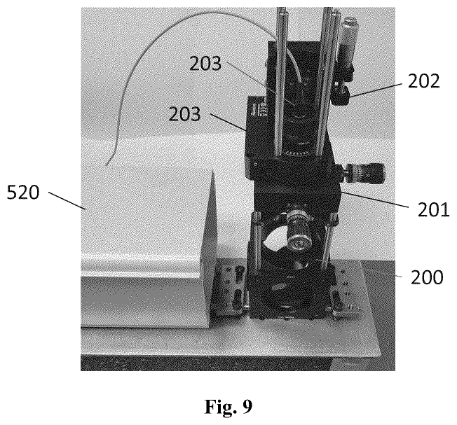

To align said optical fibers 100 and 130 to parabolic mirrors 200 and 210, respectively, optical micro-positioners are utilized. In FIG. 8, we show typical optical positioners, which can be used to perform the necessary alignment of the disclosed optical system. Linear positioner 201 provides controlled displacements in the lateral x-y directions perpendicular to the optic axis, and linear positioner 202 provides controlled displacements in the longitudinal z directions parallel to the optic axis, whereas rotation stage 203 provides rotational displacements around the optic axis defined by the central cores 103 of multicore fibers 100 and 130. Assembly of the multicore-fiber 100, linear positioners 201 and 202, rotation stage 203, parabolic mirror 200, and channel raceway 520 is shown in FIG. 9.

The disclosed free space optical system enables the use of a broad and continuous optical spectrum. Lasers or LED from visible to L band can be used in a co-propagating or counter propagating way, with zero chromatic dispersion. This enable 100's of Tbps per link without chromatic or absorption penalties present in optical fibers.

What is claimed is:

1. A low latency free-space optical data communication channel comprising:
at least two opposing parabolic mirrors for transmitting an optical communication signal in the form of a parallel beam across a free-space channel wherein the input and output of the collimators are multicore optical fibers, multiple cores of said multicore optical fibers are positioned at the focal points of the at least two opposing parabolic mirrors, and the at least two opposing parabolic mirrors image the optical communications signal in each core of the multiple cores of the multicore fibers into corresponding cores of opposing multicore fibers forming at least one optical communication channel.

2. The low latency free-space optical data communication channel according to claim 1, wherein the multicore optical fiber is a seven-core multicore fiber with one central core and six surrounding cores, and further wherein a lateral alignment of the multicore fiber is achieved using the central core and the angular alignment is achieved using the one or more of the surrounding cores.

3. The low latency free-space optical data communication channel according to claim 2, wherein power monitoring for the surrounding cores that are used as communication channels is done by tapping into a power of that channel using an optical splitter with less than 30% tapped power, thereby allowing greater than 70% channel power.

4. The low latency free-space optical data communication channel according to claim 1, wherein at least a three-core multicore fiber with one central core and at least two surrounding cores is used, and a lateral and angular alignment of multicore fibers is achieved using one or more of the surrounding cores.

5. The low latency free-space optical data communication channel according to claim 4, wherein power monitoring for the surrounding cores that are used as communication channels is done by tapping into a power of that channel using an optical splitter with less than 30% tapped power, thereby allowing greater than 70% channel power.

6. A free-space optical channel comprising multicore fibers which enable a larger number of spatial channels with a smaller optics footprint wherein a CPU or controller uses signals from one or more cores of the multicore fiber to monitor the quality of a link and to correct for defocus and lateral or angular misalignments of a channel.

7. The low latency free-space optical data communication channel, according to claim 1, wherein lasers or LEDs can transmit data at any frequency from visible light to 1650 nm, in co-propagating or counter propagation directions (bidirectional) enabling data rates of 100's of Tbps without chromatic dispersion or absorption typically occurring in optical fiber.
